(19) United States
(12) Patent Application Publication
(10) Pub. No.: US 2025/0353149 A1
(43) Pub. Date: Nov. 20, 2025

(54) REMOVAL TOOL

(71) Applicant: TIEN-I INDUSTRIAL CO., LTD., Taichung City (TW)

(72) Inventor: Larry LEE, Taichung City (TW)

(21) Appl. No.: 18/667,249

(22) Filed: May 17, 2024

(51) Int. Cl. B25B 23/00; B25B 13/06

(52) U.S. Cl. CPC B25B 23/0035; B25B 13/06

(57) ABSTRACT

A removal tool configured to be attached to a gripped member is provided. The gripped member includes a through hole extending in a first direction, and a first side and a second side located at opposing sides of the first direction. The removal tool includes: a driving member configured to be inserted in the through hole from the first side in the first direction; and a retainer configured to be disposed on the second side to prevent the driving member form disengaging from the through hole in the first direction.

### BACKGROUND OF THE INVENTION

### Field of the Invention

The present invention relates to a removal tool.

### Description of the Prior Art

In equipment or devices, fasteners, such as screws, bolts, nuts, screws or the like, are often used to connect two member or parts. Various hand tools, such as sockets, extension rod or the like, usually cooperate with drive members to turn the fasteners.

However, when using a hand tool to drive the driving member to rotate to rotate the fastener, it often happens that the driving member easily detaches from the hand tool. As a result, the user needs to hold the hand tool with one hand and hold the driving member with the other hand, such that there is no free hand for other operation.

The present invention is, therefore, arisen to obviate or at least mitigate the above-mentioned disadvantages.

### SUMMARY OF THE INVENTION

The main object of the present invention is to provide a removal tool which prevents disengagement thereof.

To achieve the above and other objects, a removal tool configured to be attached to a gripped member is provided. The gripped member includes a through hole extending in a first direction, and a first side and a second side located at opposing sides of the first direction. The removal tool includes: a driving member configured to be inserted in the through hole from the first side in the first direction; and a retainer configured to be disposed on the second side to prevent the driving member form disengaging from the through hole in the first direction.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a breakdown drawing of an exemplary embodiment of the present invention;

FIG. 2 is another breakdown drawing of an exemplary embodiment of the present invention;

FIG. 3 is a drawing showing a retainer in hand according to an exemplary embodiment of the present invention;

FIGS. 4 to 6 are drawings showing assembling of a removal tool to a gripped member according to an exemplary embodiment of the present invention; and

FIG. 7 is a partial cross-sectional view of an exemplary embodiment of the present invention.

### DETAILED DESCRIPTION OF THE PREFERRED EMBODIMENTS

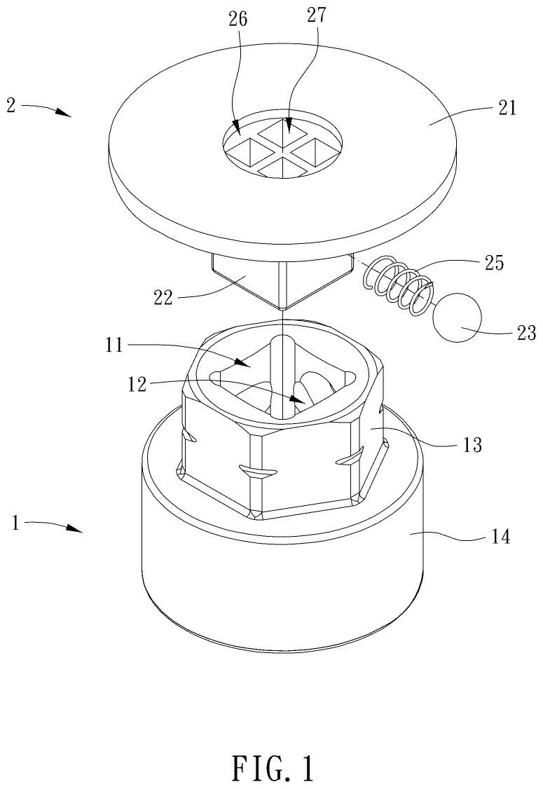

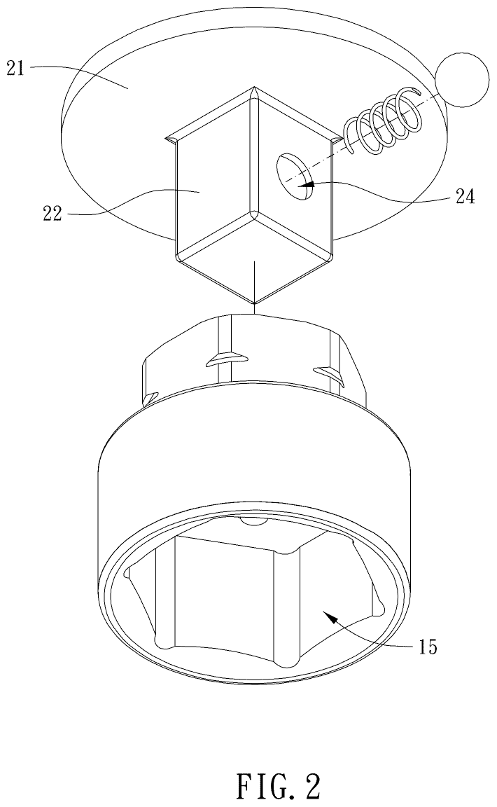

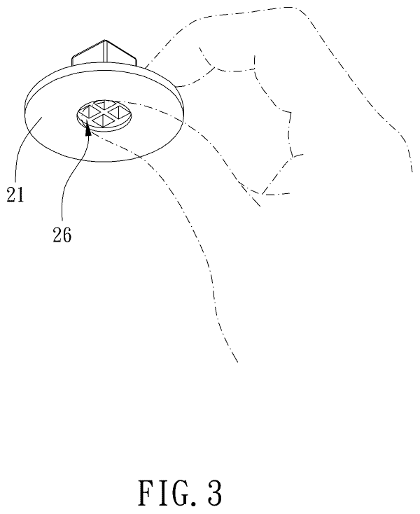

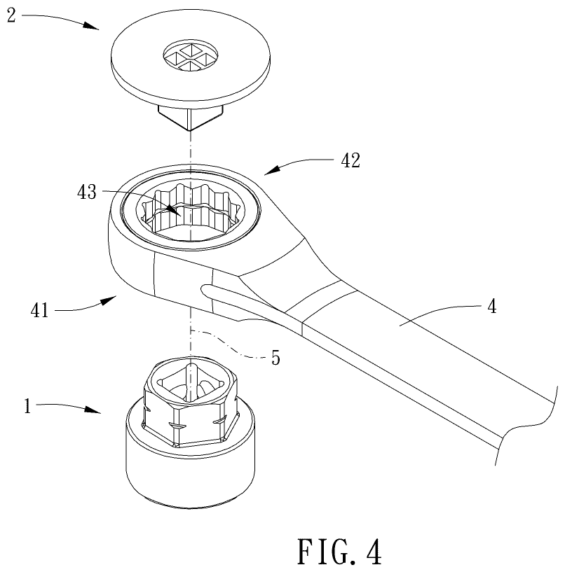

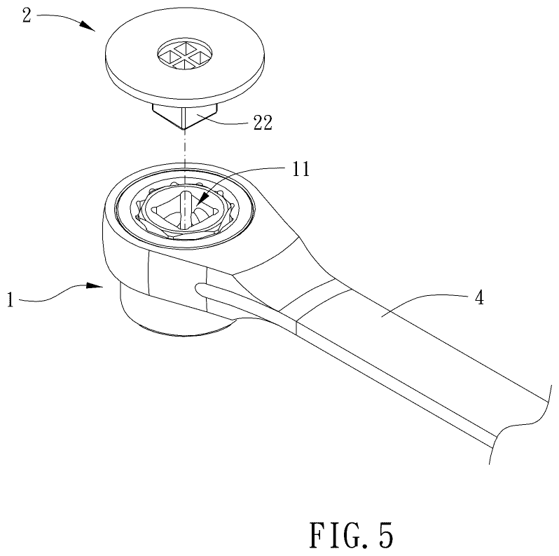

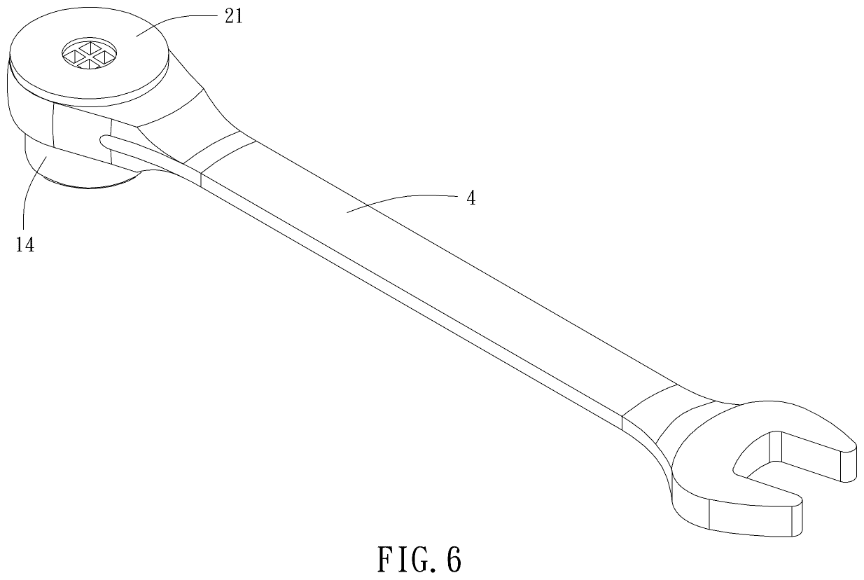

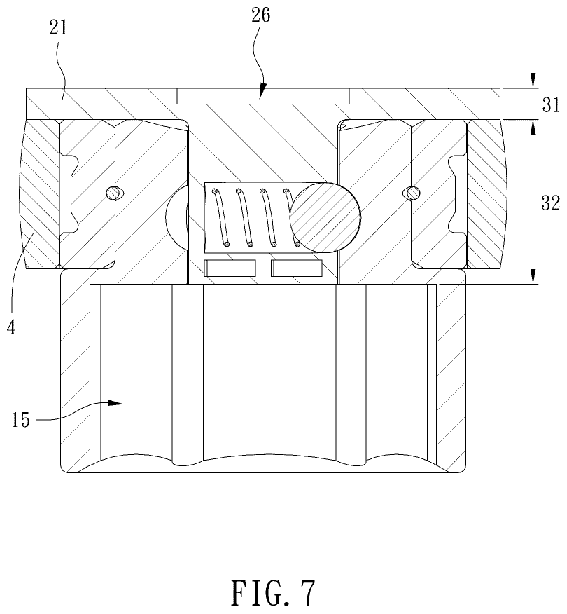

Please refer to FIGS. 1 to 7 for an exemplary embodiment of the present invention. A removal tool of the present invention is configured to be attached to a gripped member 4, such as ratchet wrench, open-end wrench, ring wrench, tubing wrench or the like. The gripped member 4 includes a through hole 43 extending in a first direction 5, and a first side 41 and a second side 42 located at opposing sides of the first direction 5. The removal tool includes a driving member 1 and a retainer 2.

The driving member 1 is configured to be inserted in the through hole 43 from the first side 41 in the first direction 5. The gripped member 4 can be operated to drive the driving member 1 to rotate an object such as a nut, bolt or the like. The retainer 2 is configured to be disposed on the second side 42 to prevent the driving member 1 form disengaging from the through hole 43 in the first direction 5, which ensures that the driving member 1 is stably retained in the through hole 43 and movable with the gripped member. The retainer 2 and the driving member 1 are detachable form each other so that it can be applied to various types of gripped members.

The driving member 1 includes an insertion hole 11 and a positioning hole 12, the positioning hole 12 is disposed on an inner surface of the insertion hole 11, and the retainer 2 includes a block portion 21, a column 22 and a detent portion 23. The block portion 21 is plate-shaped, the column 22 is square, the column 22 projects laterally from the block portion 21, a portion of the gripped member 4 around the through hole 43 is blocked by the block portion 21 in the first direction 5, and the detent portion 23 projects radially from the column 22. The column 22 is configured to be inserted in the insertion hole 11, the detent portion 23 is configured to be inserted in the positioning hole 12 so that the retainer 2 and the driving member 1 are connected to each other. In this embodiment, the retainer 2 further includes a receiving hole 24 and an elastic member 25, and the detent portion 23 is a ball member and movably received in the receiving hole 24. The elastic member 25 is received in the receiving hole 24 and abutted between an inner surface of the receiving hole 24 and the detent portion 23, for urging the detent portion 23 to project out beyond the receiving hole 24.

The block portion 21 is configured to abut the gripped member 4 at the second side 42, such that the block portion 21 and the gripped member 4 can have a larger contact area to stably support the weight of the driving member 1. In this embodiment, a thickness of the block portion 21 is defined as a first dimension 31, a height of the column 22 from the block portion 21 is defined as a second dimension 32, and a ratio of the second dimension 32 and the first dimension 31 is at least larger than 2 so that it ensures that the column 22 can be inserted in the insertion hole 11 with a sufficient depth.

The driving member 1 includes an insertion portion 13 and a connection portion 14 connected to each other, the insertion portion 13 is configured to be inserted in the through hole 43, the insertion portion 13 includes the insertion hole 11 and the positioning hole 12, the connection portion 14 includes a socket hole 15, and the socket hole 15 is in communication with the insertion hole 11. The block portion 21 has a radial dimension larger than a radial dimension of the insertion portion 13 and a radial dimension of the connection portion 14.

The block portion 21 and the column 22 may be made of plastic and formed in one piece, which provides a light weight of the retainer 2; and the driving member 1 may be made of metal, which provides a good structural strength and durability. A ratio of the weight of the retainer 2 and the weight of the driving member 1 ranges from 0.02 to 0.6.

Preferably, a side of the retainer 2 opposite to the driving member 1 includes a recess 26, and the recess 26 is circular. The recess 26 is configured for insertion of the finger(s) to increase the contact between the retainer 2 and the finger(s) at different angles, thus improving the holding stability.

In this embodiment, the recess 26 is located at the center of the retainer 2, the recess 26 and the column 22 are coaxially arranged, the recess 26 has a largest dimension larger than a largest dimension of the column 22, and a bottom of the recess 26 includes a plurality of compartments 27.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A removal tool configured to be attached to a gripped member, the gripped member including a through hole extending in a first direction, and a first side and a second side located at opposing sides of the first direction, the removal tool including:
a driving member configured to be inserted in the through hole from the first side in the first direction; and
a retainer configured to be disposed on the second side to prevent the driving member form disengaging from the through hole in the first direction.

2. The removal tool of claim 1, wherein the driving member includes an insertion hole and a positioning hole, the positioning hole is disposed on an inner surface of the insertion hole, the retainer includes a block portion, a column and a detent portion, the column projects laterally from the block portion, a portion of the gripped member around the through hole is blocked by the block portion in the first direction, the detent portion projects radially from the column; the column is configured to be inserted in the insertion hole, and the detent portion is configured to be inserted in the positioning hole so that the retainer and the driving member are connected to each other.

3. The removal tool of claim 2, wherein the block portion is plate-shaped, a thickness of the block portion is defined as a first dimension, a height of the column from the block portion is defined as a second dimension, and a ratio of the second dimension and the first dimension is at least larger than 2.

4. The removal tool of claim 2, wherein the retainer further includes a receiving hole and an elastic member, the detent portion is movably received in the receiving hole, and the elastic member is received in the receiving hole and abutted between an inner surface of the receiving hole and the detent portion.

5. The removal tool of claim 2, wherein the block portion and the column are made of plastic and formed in one piece, and the driving member is made of metal.

6. The removal tool of claim 2, wherein a side of the retainer opposite to the driving member includes a recess.

7. The removal tool of claim 6, wherein the recess and the column are coaxially arranged.

8. The removal tool of claim 7, wherein the recess has a largest dimension larger than a largest dimension of the column.

9. The removal tool of claim 1, wherein a ratio of the weight of the retainer and the weight of the driving member ranges from 0.02 to 0.6.

10. The removal tool of claim 3, wherein the retainer further includes a receiving hole and an elastic member, the detent portion is movably received in the receiving hole, and the elastic member is received in the receiving hole and abutted between an inner surface of the receiving hole and the detent portion; the block portion and the column are made of plastic and formed in one piece, and the driving member is made of metal; a ratio of the weight of the retainer and the weight of the driving member ranges from 0.02 to 0.6; a side of the retainer opposite to the driving member includes a recess; the recess and the column are coaxially arranged; the recess has a largest dimension larger than a largest dimension of the column; the recess is located at the center of the retainer, and a bottom of the recess includes a plurality of compartments; the column is square; the recess is circular; the block portion is configured to abut the gripped member at the second side; the driving member includes an insertion portion and a connection portion connected to each other, the insertion portion is configured to be inserted in the through hole, the insertion portion includes the insertion hole and the positioning hole, the connection portion includes a socket hole, and the socket hole is in communication with the insertion hole; the block portion has a radial dimension larger than a radial dimension of the insertion portion and a radial dimension of the connection portion.
